(19) United States
(12) Patent Application Publication
(10) Pub. No.: US 2020/0073488 A1
(43) Pub. Date: Mar. 5, 2020

(54) MOUSE DEVICE

(71) Applicant: Chicony Electronics Co., Ltd., New Taipei City (TW)

(72) Inventor: Yu-Chih Cheng, New Taipei City (TW)

(21) Appl. No.: 16/533,501

(22) Filed: Aug. 6, 2019

(30) Foreign Application Priority Data
Aug. 28, 2018 (TW) 107130035

(51) Int. Cl. G06F 3/0362; G06F 3/0354

(52) U.S. Cl. CPC G06F 3/0362; G06F 3/03543

(57) ABSTRACT

A mouse device includes a mouse roller structure. The mouse roller structure includes a fixed seat, a roller, a ratchet, and a swing seat. The roller has a central shaft. The central shaft is pivoted to the fixed seat. The ratchet is adjacent to the roller in parallel and coaxially fixed to the central shaft. The ratchet and the roller rotate simultaneously. An outer circumferential surface of the ratchet has an outer circumferential tooth. The swing seat includes a pivoting portion and an abutting portion. The pivoting portion is pivoted to the fixed seat. The abutting portion is fixed with an L-shaped fixing plate. An end of the L-shaped fixing plate is bent with a folding plate. The folding plate is not in contact with the abutting portion and is spaced from the abutting portion by an interval. The folding plate is protruded with a convex portion.

### CROSS-REFERENCE TO RELATED APPLICATION

This non-provisional application claims priority under 35 U.S.C. § 119(a) to Patent Application No. 107130035 filed in Taiwan, R.O.C. on Aug. 28, 2018, the entire contents of which are hereby incorporated by reference.

### BACKGROUND

### Technical Field

The instant disclosure relates to a computer peripheral device and, more particularly, to a mouse device.

### Related Art

Mouse is a common computer input device for controlling the movement of a cursor and performing the operation relative to positions the cursor passes by keys and a roller. For instance, the cursor is controlled to perform operations such as selecting or triggering by the keys, and the roller is used to perform operations such as dragging or rolling pages.

Currently, a conventional mouse roller structure has a roller and an elastic abutting ball. The body of the roller is provided with a tooth surface. The elastic abutting ball includes a spring and a metal ball connected to an end of the spring. While the roller is operated, the roller rotates to produce a step feeling by the elastic abutting ball abutting against the tooth surface of the body of the roller. For instance, while the roller rotates to a degree in each time, the user would sense a pause feeling, and the page on a screen would be rolled by a certain distance. However, the mouse roller structure with the step feeling cannot satisfy certain scenarios (for instance, a scenario that there is a need to roll the roller for a long time or a long distance, or there is a need for a more sophisticated rolling operation).

### SUMMARY

To address the above issue, the embodiment provides a mouse device comprising a mouse roller structure. The mouse roller structure comprises a fixed seat, a roller, a ratchet, and a swing seat. The roller has a central shaft. The central shaft is pivoted to the fixed seat. The ratchet is adjacent to a side of the roller in parallel and is coaxially fixed to the central shaft. The ratchet and the roller rotate simultaneously. An outer circumferential surface of the ratchet has an outer circumferential tooth. The swing seat comprises a pivoting portion and an abutting portion. The pivoting portion is pivoted to the fixed seat. The abutting portion is fixed with an L-shaped fixing plate. An end of the L-shaped fixing plate is bent with a folding plate. The folding plate is not in contact with the abutting portion and is spaced from the abutting portion by an interval. The folding plate is protruded with a convex portion. Wherein, the swing seat is capable of swinging about the pivoting portion, such that the abutting portion is capable of being selectively away from the ratchet or close to the ratchet so as to make the convex portion of the folding plate radially abut against the outer circumferential tooth of the ratchet.

Concisely, the swing seat of the mouse roller structure of the mouse device according to the embodiment of the instant disclosure is capable of swinging about the pivoting portion relative to the fixed seat to make the abutting portion be away from the ratchet or be close to the ratchet so as to make the convex portion of the folding plate radially abut against the outer circumferential tooth of the ratchet, so as to switch the roller to a non-step mode or a step mode to meet different needs of operations of users.

### BRIEF DESCRIPTION OF THE DRAWINGS

FIG. 1 illustrates a perspective view of a mouse device according to an embodiment of the instant disclosure;

FIG. 2 illustrates a perspective view of a mouse roller structure according to an embodiment of the instant disclosure;

FIG. 3 illustrates an exploded view of a mouse roller structure according to an embodiment of the instant disclosure;

FIG. 4 illustrates a schematic view of abutting of the mouse roller structure according to an embodiment of the instant disclosure;

FIG. 5 illustrates a schematic view of releasing of the mouse roller structure according to an embodiment of the instant disclosure; and

FIG. 6 illustrates an exploded view of a mouse roller structure according to another embodiment of the instant disclosure.

### DETAILED DESCRIPTION

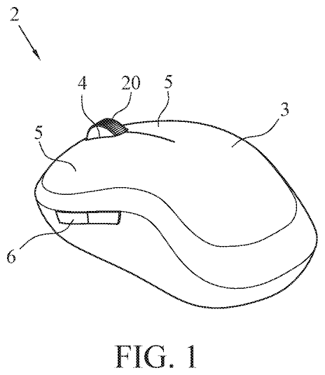

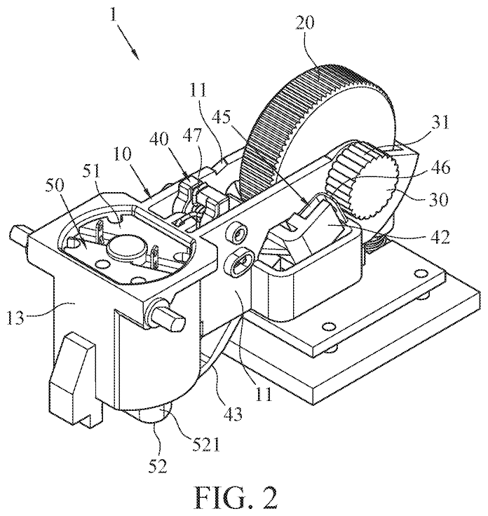

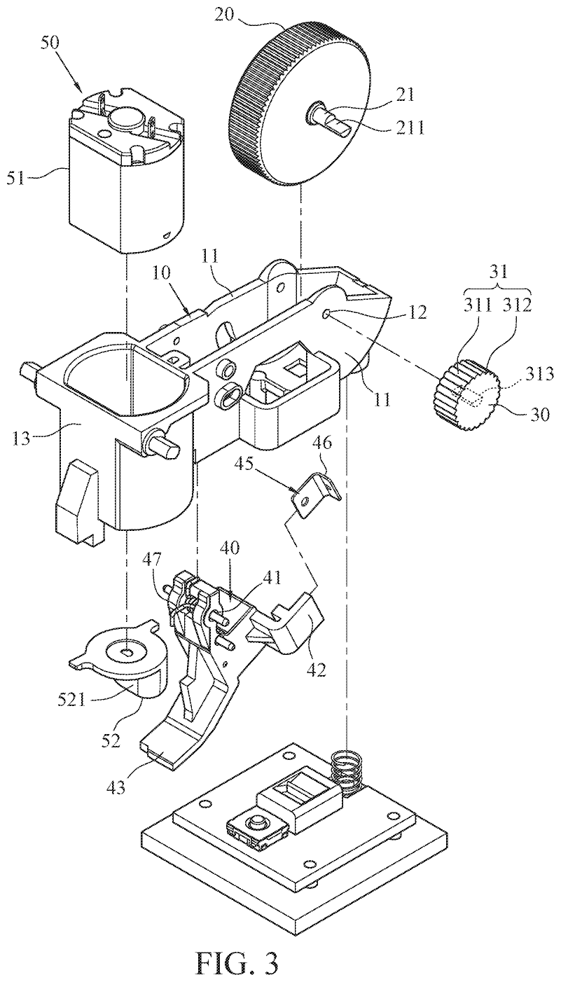

FIG. 1 is a perspective view of a mouse device according to an embodiment of the instant disclosure. FIG. 2 is a perspective view of a mouse roller structure according to an embodiment of the instant disclosure. FIG. 3 is an exploded view of a mouse roller structure according to an embodiment of the instant disclosure. As shown in FIG. 1 and FIG. 2, a mouse device 2 comprises a housing 3 and a mouse roller structure 1. In the embodiment, the mouse device 2 is a computer input device for controlling a mouse cursor of a computer (e.g., controlling the mouse cursor to perform operation of moving or clicking). In some embodiments, the mouse device 2 is, in particular, a mechanical mouse, an optical mouse, or a laser mouse. In terms of transmission measure, the mouse device 2 may be a wire mouse. For instance, the mouse device 2 can be connected to a port of a computer (e.g., an USB port) by a wire and can transmit data to computer by the wire. Alternatively, the mouse device 2 may be a wireless mouse to perform a wireless transmission with a computer by infrared radio frequency or Bluetooth.

As shown in FIG. 1, a surface of the housing 3 of the mouse device 2 is provided with a through hole 4 communicating with an internal space of the housing 3. In the embodiment, the mouse device 2 is a two-key mouse, the through hole 4 is disposed on the top surface of the mouse device 2 and between two keys 5, but it is not limited thereto. The mouse device 2 may be a one-key mouse or a mouse with three or more keys. Please refer to FIG. 1 and FIG. 2 again. The mouse roller structure 1 comprises a fixed seat 10, a roller 20, a ratchet 30, and a swing seat 40. In the embodiment, the mouse roller structure 1 is disposed inside the housing 3 of the mouse device 2. A part of the roller 20 of the mouse roller structure 1 penetrates through the through hole 4, such that the part of the roller 20 is exposed from the housing 3 for being operated by a user. For instance, the roller 20 is for being operated to roll to perform action such as rolling pages.

As shown in FIG. 2 and FIG. 3, the roller 20 of the mouse roller structure 1 has a central shaft 21. The central shaft 21 is pivoted to the fixed seat 10, such that while the roller 20 is applied with force, the roller 20 can rotate about the central shaft 21 relative to the fixed seat 10. In the embodiment, the fixed seat 10 comprises two side walls 11 spaced from each other. One of the side walls 11 is provided with a shaft connecting hole 12. The roller 20 is disposed between the two side walls 11. The central shaft 21 penetrates through the side wall 11 via the shaft connecting hole 12.

As shown in FIG. 2 and FIG. 3, the ratchet 30 of the mouse roller structure 1 is adjacent to a side of the roller 20 in parallel and is coaxially fixed to the central shaft 21. For instance, in the embodiment, the ratchet 30 and the roller 20 are axially in parallel with each other, and the ratchet 30 is outside the fixed seat 10 and coaxially fixed to a part of the central shaft 21 penetrating through the side wall 11; therefore, the ratchet 30 and the roller 20 are adjacent to each other and keep an interval there between without contacting with each other. The ratchet 30 and the roller 20 can rotate simultaneously. In some embodiments, the radius of the ratchet 30 may be less than that of the roller 20 (as shown in FIG. 2 and FIG. 3) but not limited thereto.

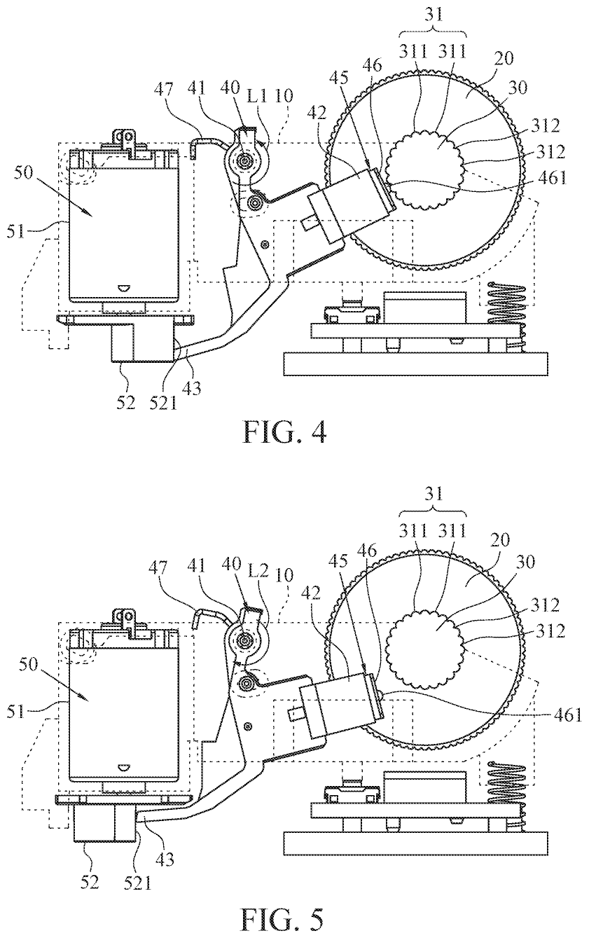

As shown in FIG. 3 and FIG. 4, an outer circumferential surface of the ratchet 30 may have an outer circumferential tooth 31. In the embodiment, the outer circumferential tooth 31 is composed of a continuous convex-concave structure. In the embodiment, the outer circumferential tooth 31 comprises a plurality of teeth 311 aligned annularly, such that there is a trough 312 formed between two adjacent teeth 311. In some embodiments, each tooth 311 extends along the axial direction of the ratchet 30. A cross section of each tooth 311 is, but not limited to, of a circular shape (as shown in FIG. 2 and FIG. 3), a rectangular shape, a trapezoidal shape, or other shapes.

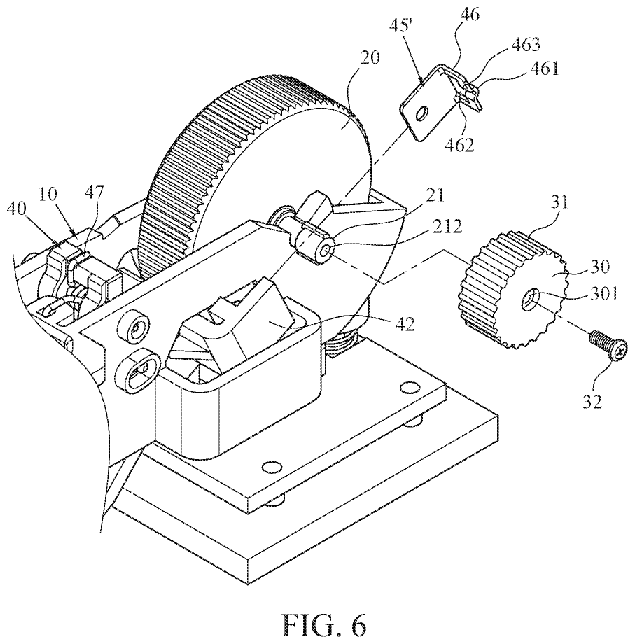

In some embodiments, the ratchet 30 and the central shaft 21 can be fixed to each other in a manner of adhering, locking, coupling, or tight fitting. As shown in FIG. 3, in the embodiment, an end of the central shaft 21 penetrating through the side wall 11 is provided with a semicircular notch 211, such that a cross section of the end of the central shaft 21 presents a semicircular shape. A center of the ratchet 30 has a semicircular shaft hole 313 corresponding to a shape of the end of the central shaft 21 and is sleeved on the end of the central shaft 21 by the semicircular shaft hole 313, such that while the roller 20 rotates, the roller 20 can drive the ratchet 30 to rotate simultaneously to avoid the dislocation between the ratchet 30 and the central shaft 21. Alternatively, as shown in FIG. 6, in another embodiment, the end of the central shaft 21 may be provided with a locking hole 212 (e.g., a threaded hole), and the center of the ratchet 30 may have a shaft hole 301 corresponding to the locking hole 212. As a result, in the embodiment, the ratchet 30 can be fixed to the central shaft 21 by a locking member 32 (e.g., a screw or a bolt) penetrating through the shaft hole 301 and being accordingly locked in the locking hole 212.

As shown in FIG. 3 to FIG. 5, the swing seat 40 comprises a pivoting portion 41 and an abutting portion 42. In the embodiment, the swing seat 40 is disposed between the two side walls 11 of the fixed seat 10 and is at a side of the roller 20. In the embodiment, the pivoting portion 41 is disposed at a pivoting hole of the swing seat 40. The swing seat 40 can be pivoted to the fixed seat 10 by a shaft via the pivoting portion 41, such that while the swing seat 40 is applied with force, the swing seat 40 can swing about the pivoting portion 41 relative to the fixed seat 10. An end of the swing seat 40 further extends to be close to the ratchet 30, and the abutting portion 42 is an end of the swing seat 40 close to the ratchet 30.

As shown in FIG. 3 to FIG. 5, the abutting portion 42 of the swing seat 40 is fixed with an L-shaped fixing plate 45. An end of the L-shaped fixing plate 45 is bent with a folding plate 46. The folding plate 46 is not in contact with the abutting portion 42 and spaced from the abutting portion 42 by an interval. In the embodiment, the L-shaped fixing plate 45 is integrally formed by a plate (e.g., a metal plate) being bent. The L-shaped fixing plate 45 can be assembled to and fixed to the abutting portion 42 of the swing seat 40 in a manner of adhering, locking or coupling. The folding plate 46 is at an end of the L-shaped fixing plate 45 close to the ratchet 30. The folding plate 46 is not fixed to the abutting portion 42 and is spaced from the abutting portion 42, such that the folding plate 46 can be elastically deformed while being applied with force. In addition, the folding plate 46 is further provided with a convex portion 461. In the embodiment, the convex portion 461 is integrally formed on the surface of the folding plate 46. For instance, in the embodiment, the convex portion 461 is a convex point formed on the surface of the folding plate 46. In particular, in the manufacturing process, the convex portion 461 can be integrally formed by stamping the surface of the folding plate 46 by a machine. But it is not limited thereto. In other embodiments, the convex portion 461 and the folding plate 46 can be integrally formed in a metal injection molding manner. Alternatively, the convex portion 461 can be a piece of a block and can be fixed to the surface of the folding plate 46 in a processing manner (e.g., soldering or adhering).

In an embodiment, the swing seat 40 is connected to a driving member 50, such that the driving member 50 drives the swing seat 40 to swing about the pivoting portion 41 relative to the fixed seat 10 to make the abutting portion 42 be close to or away from the ratchet 30. In the embodiment, the driving member 50 can be, but not limited to, an electric driving member or a manual riving member. As shown in FIG. 2 and FIG. 3, in the embodiment, the swing seat 40 has a driven portion 43. The driven portion 43 is an end of the swing seat 40 away from the ratchet 30. The pivoting portion 41 is between the driven portion 43 and the abutting portion 42. The driving member 50 comprises an electric motor 51 and a cam member 52 connected to the electric motor 51. In the embodiment, an end of the fixed seat 10 away from the roller 20 is provided with a motor fixing seat 13. The swing seat 40 is between the ratchet 30 and the motor fixing seat 13. The electric motor 51 is fixed to the motor fixing seat 13. The cam member 52 is connected to a driving shaft (not shown) of the electric motor 51, such that while the electric motor 51 operates, the electric motor 51 drives the cam member 52 to rotate. The cam member 52 has an outer circumference 521. The outer circumference 521 is against the driven portion 43 of the swing seat 40. In the embodiment, the cam member 52 is a disc-shaped member with a varied diameter. While the electric motor 51 drives the cam member 52 to rotate, the driven portion 43 of the swing seat 40 can reciprocate along an outline of the outer circumference 521 and can drive the swing seat 40 to swing.

Nonetheless, the above embodiments are merely examples. In other embodiments, the driving member 50 may only comprise the electric motor 51. The driving shaft of the electric motor 51 can be directly connected to the pivoting portion 41 of the swing seat 40, such that while the electric motor 51 operates, the swing seat 40 can be directly driven to swing. Alternatively, the driving member 50 may also comprise a manual extendable rod (not shown) and be connected to the driven portion 43 of the swing seat 40, such that the swing seat 40 can be driven to swing by an extending-contracting movement of the manual extendable rod.

Please refer to FIG. 1 to FIG. 3, in some embodiments, an external of the mouse device 2 may be provided with a starting switch 6. The starting switch 6 is electrically connected to the electric motor 51; therefore, the user can control the electric motor 51 to operate for driving the cam member 52 to rotate by the starting switch 6. In the embodiment, the electric motor 51 may be a stepper motor. While the starting switch 6 is started in each time, the electric motor 51 may rotate to a predetermined angle to accurately drive the cam member 52 to rotate to a required position. For instance, it may be predetermined that while the electric motor 51 is started by the starting switch 6 in each time, the electric motor 51 will drive the cam member 52 to rotate to 180 degrees.

The following description regards the swing seat 40 swinging to make the abutting portion 42 be close to or be away from the ratchet 30 to switch the roller 20 to a step mode or a non-step mode. As shown in FIG. 4, in the embodiment, while the electric motor 51 is started to drive the cam member 52 to rotate to an abutting position (the position of the cam member 52 as shown in FIG. 4), during the rotation of the cam member 52, the driven portion 43 of the swing seat 40 is pushed by the cam member 52 and moved towards the ratchet 30 and the roller 20, such that the swing seat 40 as a whole is driven to swing about the pivoting portion 41 relative to the fixed seat 10 (swinging counterclockwise as shown by the arrow L1 in the drawing) to make the abutting portion 42 of the swing seat 40 be close to the ratchet 30 and make the convex portion 461 of the folding plate 46 of the L-shaped fixing plate 45 radially abut against the outer circumferential tooth 31 of the ratchet 30. Accordingly, the roller 20 is switched to the step mode. In the step mode, the outer circumferential tooth 31 of the ratchet 30 is elastically abutted against by the convex portion 461 of the folding plate 46 due to the coaxial configuration of the roller 20 and the ratchet 30; therefore, while the roller 20 is operated to rotate, the roller 20 produces a step feeling. For instance, while the roller 20 rotates to drive the ratchet 30 to rotate simultaneously, the convex portion 461 of the folding plate 46 leaves one of the troughs 312 of the ratchet 30, crosses the adjacent tooth 311, and then elastically abuts against another one of the troughs 312, such that the user can sense the pause feeling.

As the above description, as shown in FIG. 5, while the electric motor 51 is started to drive the cam member 52 to rotate to a releasing position (the position of the cam member 52 as shown in FIG. 5), during the rotation, the driven portion 43 of the swing seat 40 is moved away from the ratchet 30 and the roller 20 along the outline of the outer circumference 521 of the cam member 52, such that the swing seat 40 as a whole is driven to swing about the pivoting portion 41 relative to the fixed seat 10 (swinging clockwise as shown by the arrow L2 in the drawing) to make the abutting portion 42 of the swing seat 40 be away from the ratchet 30 and make the convex portion 461 of the folding plate 46 of the L-shaped fixing plate 45 detach from the outer circumferential tooth 31 of the ratchet 30. Accordingly, the roller 20 is switched to the non-step mode. In the non-step mode, the outer circumferential tooth 31 of the ratchet 30 is applied with no resistance; therefore, while the roller 20 is operated to rotate, the roller 20 does not produce any step feeling, such that the roller 20 can be rotated faster or can be used to perform a more sophisticated operation, which is beneficial for certain scenarios (for instance, a scenario that there is a need to roll the roller 20 for a long time or a long distance, or there is a need for a more sophisticated rolling operation).

Concisely, the mouse roller structure 1 according to the embodiment of the instant disclosure can make the abutting portion 42 be away from the ratchet 30 or be close to the ratchet 30 by driving the swing seat 40 to swing, so as make the convex portion 461 of the folding plate 46 of the L-shaped fixing plate 45 detach from or radially abut against the outer circumferential tooth 31 of the ratchet 30, such that the roller 20 can be switched to the non-step mode or the step mode to meet different needs of operations of users.

Other than the above advantages, the ratchet 30 is coaxially fixed to the central shaft 21 of the roller 20 according to the embodiment of the instant disclosure. Comparing to the conventional roller structure, there is no need of additional process to process the tooth surface of the body of the roller 20 (e.g., the process of forming troughs and providing an internal tooth surface on the internal of the roller 20), and the arrangement of the abutting portion 42 of the swing seat 40 and the ratchet 30 can be more flexible, i.e., it won't be restricted by the position of the roller 20. In addition, the L-shaped fixing plate 45 abuts against the outer circumferential tooth 31 of the ratchet 30 according to the embodiment of the instant disclosure. Comparing to the measure of using elastic ball in the prior art, it can lower the cost and can be benefit to the adjustment of manufacturing process. Specifically, the L-shaped fixing plate 45 according to the embodiment of the instant disclosure is integrally formed by a plate (e.g., a metal plate) being bent. Comparing to a conventional spring of the elastic ball and metal ball, it has lower cost and greater structural strength. Moreover, in the manufacturing process according to the embodiment of the instant disclosure, the thickness and bent portion of the L-shaped fixing plate 45 or the interval between the folding plate 46 and the abutting portion 42 can be easily altered to adjust an abutting stress of the convex portion 461 of the folding plate 46 elastically abutting against the outer circumferential tooth 31 of the ratchet 30 to meet the needs of products with different specifications.

As shown in FIG. 2 and FIG. 3, in the embodiment, the swing seat 40 is further provided with a restoring spring 47 (it is, but not limited to, a torsional spring in the embodiment). An end of the restoring spring 47 is connected to the swing seat 40 (in the embodiment, the end of the restoring spring 47 surrounds the pivoting portion 41 of the swing seat 40), and another end thereof is against the fixed seat 10. As shown in FIG. 4, while the electric motor 51 is started to drive the cam member 52 to rotate to the abutting position to make the swing seat 40 swing counterclockwise to make the abutting portion 42 be close to the ratchet 30, the restoring spring 47 is compressed by force and accumulates resilience. As shown in FIG. 5, while the electric motor 51 is started to drive the cam member 52 to rotate to the releasing position, the accumulated resilience of the restoring spring 47 can help the swing seat 40 to swing clockwise to reset.

As shown in FIG. 6, in another embodiment, the difference between the L-shaped fixing plate 45′ and the L-shaped fixing plate 45 of FIG. 3 is that the folding plate 46 of the L-shaped fixing plate 45′ is further provided with a hollow hole 462, and a side of the hollow hole 462 is formed with a side arm 463. The convex portion 461 is disposed on the side arm 463. For instance, the folding plate 46 is formed with the hollow hole 462 in a punching process, and then the convex portion 461 is integrally formed by stamping or bending the side arm 463 by machine. As a result, while the convex portion 461 of the side arm 463 abuts against the outer circumferential tooth 31 of the ratchet 30, the abutting stress can be lowered to decrease the resistance during the rotation of the roller 20.

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A mouse device, comprising:
a mouse roller structure, comprising:
a fixed seat;
a roller having a central shaft, the central shaft being pivoted to the fixed seat;
a ratchet adjacent to a side of the roller in parallel and coaxially fixed to the central shaft, the ratchet and the roller rotating simultaneously, an outer circumferential surface of the ratchet having an outer circumferential tooth; and
a swing seat comprising a pivoting portion and an abutting portion, the pivoting portion being pivoted to the fixed seat, the abutting portion being fixed with an L-shaped fixing plate, an end of the L-shaped fixing plate being bent with a folding plate, the folding plate being not in contact with the abutting portion and spaced from the abutting portion by an interval, the folding plate being protruded with a convex portion;
Wherein, the swing seat is capable of swinging about the pivoting portion, such that the abutting portion is capable of being selectively away from the ratchet or close to the ratchet so as to make the convex portion of the folding plate radially abut against the outer circumferential tooth of the ratchet.

2. The mouse device of claim 1, wherein the convex portion is integrally formed on a surface of the folding plate.

3. The mouse device of claim 2, wherein the convex portion is a convex point.

4. The mouse device of claim 2, wherein the folding plate is further provided with a hollow hole.

5. The mouse device of claim 4, wherein a side of the hollow hole is formed with a side arm, and the convex portion is disposed on the side arm.

6. The mouse device of claim 1, wherein the swing seat is connected to a driving member, and the driving member drives the swing seat to swing about the pivoting portion.

7. The mouse device of claim 6, wherein the swing seat comprises a driven portion, the pivoting portion is between the driven portion and the abutting portion, and the driving member is connected to the driven portion.

8. The mouse device of claim 7, wherein the driving member comprises an electric motor and a cam member connected to the electric motor, the cam member has an outer circumference, and the outer circumference is against the driven portion of the swing seat.

9. The mouse device of claim 1, wherein an end of the central shaft is further provided with a semicircular notch, a center of the ratchet has a semicircular shaft hole, and the ratchet is sleeved on the end of the central shaft by the semicircular shaft hole.

10. The mouse device of claim 1, wherein the swing seat is further provided with a restoring spring, an end of the restoring spring is connected to the swing seat, and an another end of the restoring spring is against the fixed seat.

11. The mouse device of claim 1, further comprising a housing, wherein a surface of the housing is provided with a through hole, the mouse roller structure is disposed inside the housing, and a part of the roller penetrates through the through hole.
